(19) United States
(12) Patent Application Publication
(10) Pub. No.: US 2012/0230216 A1
(43) Pub. Date: Sep. 13, 2012

(54) COMMUNICATION METHOD

(75) Inventors: Jisoo Park, Daejeon (KR); Namsuk Lee, Daejeon (KR); Sook Jin Lee, Daejeon (KR); Youn Ok Park, Daejeon (KR); Dong Seung Kwon, Daejeon (KR)

(73) Assignee: ELECTRONICS AND TELECOMMUNICATIONS RESEARCH INSTITUTE, Daejeon (KR)

(21) Appl. No.: 13/505,108

(22) PCT Filed: Oct. 29, 2010
(86) PCT No.: PCT/KR2010/007541

§ 371 Date: Apr. 30, 2012

(30) Foreign Application Priority Data
Oct. 29, 2009 (KR) 10-2009-0103420
Oct. 29, 2010 (KR) 10-2010-0106627

(51) Int. Cl. H04W 24/10; H04W 72/04; H04J 3/14

(52) U.S. Cl. 370/252; 370/280

(57) ABSTRACT

A mobile station and a base station communicate with each other using a frame including one or more downlink subframes and one or more uplink subframes. The base station begins the transmission of a data burst in a subframe corresponding to a downlink subframe index. The mobile station transmits feedback for the data burst to the base station in a subframe corresponding to an uplink subframe index. If the frame uses a time division duplex scheme, the uplink subframe index is determined by at least using the downlink subframe index and the parameter value.

### BACKGROUND OF THE INVENTION

(a) Field of the Invention

The present invention relates to a communication method. More particularly, the present invention relates to a base station and a mobile station that use a hybrid automatic repeat request (HARQ) scheme.

(b) Description of the Related Art

A wireless mobile communication system performs communication mainly using a communication frame.

A communication frame will be described below with reference to FIGS. 1 and 2.

FIG. 1 illustrates a communication frame of a frequency division duplex (FDD) scheme in the conventional art.

As illustrated in FIG. 1, a communication frame of the frequency division duplex scheme includes F downlink subframes and F uplink subframes. F corresponds to the number of subframes of one communication frame.

Downlink subframe indices 0 to F-1 are assigned to the F downlink subframes, and uplink subframe indices 0 to F-1 are assigned to the F uplink subframes.

FIG. 2 illustrates a communication frame of a time division duplex (TDD) scheme in the conventional art.

As illustrated in FIG. 2, a communication frame of a time division duplex scheme frequency scheme includes D downlink subframes and U uplink subframes.

Downlink subframe indices 0 to D-1 are assigned to the D downlink subframes, and uplink subframe indices 0 to U-1 are assigned to the U uplink subframes.

In the wireless mobile communication system, the structure of the communication frame may be varied depending on channel width and cyclic prefix (CP) ratio. An example of this is the following table.

TABLE 1

| | | Channel BW(MHz) | | |
|---|---|---|---|---|
| CP Ratio | | 7 | 8.75 | 5, 10, 20 |
| FDD(F) | G = ⅛ | 5 | 7 | 8 |
| | G = 1/16 | 6 | | |
| TDD | G = ⅛ | 3:2, 2:3 | 5:2 | 8:0, 6:2, 5:3, |
| (D:U) | G = 1/16 | 4:2, 3:3 | 4:3 | 4:4, 3:5 |
| | | | 3:4 | |
| G = ¼ FDD (F) | | 5 | 6 | 7 |
| TDD | G = ¼ | 3:2, 2:3 | 4:2 | 5:2, 4:3, 3:4 |
| (D:U) | | | 3:3 | |
| | | | 2:4 | |

A wireless mobile communication system may use a transmission time interval (TTI) as a transmission time unit. TTI is the duration of the transmission of the physical layer encoded packet over the radio air interface, and is equal to an integer number of advanced air interface (AAI) subframes. That is, 1 TTI is the duration of transmission of a packet (subpacket or data burst) occupying a length of 1 subframe, and n TTI is the duration of transmission of a packet occupying a length of n subframes.

Moreover, a data burst may be transmitted over one subframe, or may be transmitted over a plurality of consecutive subframes. For transmission of a data burst in one frame, the duration of the data burst is referred to as one TTI or a default TTI, whereas, for transmission of a data burst over a plurality of consecutive subframes, the duration of the corresponding data burst is a Long TTI. For example, for Long TTI transmission in the FDD transmission mode, a data burst may be defined to occupy a length of four subframes.

A mobile communication system may use four types of subframes depending on the number of orthogonal frequency division multiple access (OFDMA) symbols. A type-1 subframe consists of six OFDMA symbols, a type-2 subframe consists of seven OFDMA symbols, a type-3 subframe consists of five OFDMA symbols, and a type-4 subframe consists of nine OFDMA symbols.

For example, a mobile communication system using an FDD mode with a channel bandwidth of 7 MHz, a CP ratio of 1/8, F=5, and a TDD mode with D+U=5 will be discussed below. First, as the same CP ratio is applied for the FDD mode and the TDD mode, the OFDMA symbol time (Ts) is equal in both modes. This mobile communication system uses a communication frame consisting of 1 type-1 subframe and four type-2 subframes for the FDD, and a communication frame consisting of two type-1 subframes and three type-2 subframes for the TDD. Therefore, a communication frame of FDD consists of a total of 34 OFDMA symbols, and a communication frame of TDD consists of a total of 33 OFDMA symbols. Although the communication frame of TDD has one less OFDMA symbol than the communication frame of FDD, the time required to processing a data burst and a control signal in the FDD and TDD modes is almost the same since a transmit/receive transition gap (TTG) and a receive/transmit transition gap (RTG) are used for the TDD mode.

To achieve high speed data packet transmission, low delay, and transmission reliability, mobile communication systems are making use of a hybrid automatic repeat request (HARQ) scheme that incorporates a forward error correction (FEC) scheme and an automatic repeat request (ARQ) scheme.

The retransmission scheme of the HARQ may be classified into a synchronous HARQ scheme and an asynchronous HARQ scheme depending on the transmission timing of a retransmission packet. In the synchronous HARQ scheme, the transmission timing of a retransmission packet for an initial transmission packet is kept constant. In the asynchronous HARQ scheme, a scheduler of a base station determines the transmission timing of a retransmission packet for an initial transmission packet.

The HARQ may be classified into an adaptive HARQ and a non-adaptive HARQ according to whether the amount and positions of allocated resources are varied. The adaptive HARQ is a scheme in which the amount and positions of allocated resources are varied. The non-adaptive HARQ is a scheme in which the amount and positions of allocated resources are fixed.

By properly combining the synchronous and asynchronous HARQ schemes and the adaptive and non-adaptive HARQ schemes together, and employing low signaling overhead, a high scheduling gain and a high-speed data transmission effect are achieved. For example, a mobile communication system may adopt an adaptive asynchronous HARQ for downlink data transmission and the synchronous HARQ for uplink data transmission.

As explained above, the time required to process a data burst and a control signal is almost the same in the FDD and TDD modes. Hence, the same HARQ timing should be applied for the FDD mode and the TDD mode.

### SUMMARY OF THE INVENTION

The present invention has been made in an effort to provide a communication method, a base station, and a mobile station to which the same HARQ timing is applied.

According to one aspect of the present invention, there is provided a method for a mobile station to communicate with a base station using a frame including one or more downlink subframes and one or more uplink subframes, the method including: beginning the reception of a data burst in a subframe corresponding to a downlink subframe index; if the frame uses a time division duplex scheme and the number of downlink subframes is greater than the number of uplink subframes, determining a parameter value as the greatest integer less than or equal to half the difference between the number of downlink subframes and the number of uplink subframes; if the frame uses the time division duplex scheme, determining an uplink subframe index for feedback transmission by at least using the downlink subframe index and the parameter value; and transmitting feedback for the data burst to the base station in a subframe corresponding to the uplink subframe index.

The method may further include, if the frame uses the time division duplex scheme and the number of downlink subframes is less than or equal to the number of uplink subframes, determining the parameter value as an integer obtained by multiplying the smallest integer greater than or equal to half the difference between the number of uplink subframes and the number of downlink subframes by −1.

The determining of the uplink subframe index if the frame uses the time division duplex scheme may further include: if the number of downlink subframes is greater than the number of uplink subframes, the downlink subframe index is greater than or equal to the parameter value, and the downlink subframe index is less than the sum of the parameter value and the number of uplink subframes, determining the uplink subframe index as a value obtained by subtracting the parameter value from the downlink subframe index; if the number of downlink subframes is greater than the number of uplink subframes, the downlink subframe index is greater than or equal to 0, and the downlink subframe index is less than the parameter value, determining the uplink subframe index as 0; if the number of downlink subframes is greater than the number of uplink subframes, the downlink subframe index is greater than or equal to the sum of the parameter value and the number of uplink subframes, and the downlink subframe index is less than the number of downlink subframes, determining the uplink subframe index as a value obtained by subtracting 1 from the number of uplink subframes; and if the number of downlink subframes is less than or equal to the number of uplink subframes, determining the uplink subframe index as a value obtained by subtracting the parameter value from the downlink subframe index.

The method may further include, if the frame uses a frequency division duplex scheme, determining the uplink subframe index for feedback transmission as the remainder of division of the smallest integer greater than or equal to the sum of half the number of subframes in the frame and the downlink subframe index by the number of subframes in the frame.

According to another aspect of the present invention, there is provided a method for a base station to communicate with a mobile station using a frame including one or more downlink subframes and one or more uplink subframes, the method including: beginning the transmission of a data burst in a subframe corresponding to a downlink subframe index; and receiving feedback for the data burst from the mobile station in a subframe corresponding to an uplink subframe index.

If the frame uses a time division duplex scheme, the uplink subframe index may be determined by at least using the downlink subframe index and a parameter value.

If the frame uses the time division duplex scheme and the number of downlink subframes is greater than the number of uplink subframes, the parameter value may be the greatest integer less than or equal to half the difference between the number of downlink subframes and the number of uplink subframes.

If the frame uses the time division duplex scheme and the number of downlink subframes is less than or equal to the number of uplink subframes, the parameter value may be an integer obtained by multiplying the smallest integer greater than or equal to half the difference between the number of uplink subframes and the number of downlink subframes by −1.

If the frame uses a frequency division duplex scheme, the uplink subframe index may be the remainder of division of the smallest integer greater than or equal to the sum of half the number of subframes in the frame and the downlink subframe index by the number of subframes in the frame.

According to another aspect of the present invention, there is provided a method for a mobile station to communicate with a base station using a frame including one or more downlink subframes and one or more uplink subframes, the method including: receiving resource allocation information in a subframe corresponding to a downlink subframe index; if the frame uses a time division duplex scheme and the number of downlink subframes is greater than or equal to the number of uplink subframes, determining a parameter value as the greatest integer less than or equal to half the difference between the number of downlink subframes and the number of uplink subframes; if the frame uses the time division duplex scheme, determining an uplink subframe index by at least using the downlink subframe index and the parameter value; and beginning the transmission of a data burst corresponding to the resource allocation information in a subframe corresponding to the uplink subframe index.

The method may further include, if the frame uses the time division duplex scheme and the number of downlink subframes is less than the number of uplink subframes, determining the parameter value as an integer obtained by multiplying the smallest integer greater than or equal to half the difference between the number of uplink subframes and the number of downlink subframes by −1.

The determining of the uplink subframe index if the frame uses the time division duplex scheme may further include: if the number of downlink subframes is greater than or equal to the number of uplink subframes, the downlink subframe index is greater than or equal to the parameter value, and the downlink subframe index is less than the sum of the parameter value and the number of uplink subframes, determining the uplink subframe index as a value obtained by subtracting the parameter value from the downlink subframe index; if the number of downlink subframes is greater than or equal to the number of uplink subframes, the downlink subframe index is greater than or equal to 0, and the downlink subframe index is less than the parameter value, determining the uplink subframe index as 0; if the number of downlink subframes is greater than or equal to the number of uplink subframes, the downlink subframe index is greater than or equal to the sum of the parameter value and the number of uplink subframes, and the downlink subframe index is less than the number of downlink subframes, determining the uplink subframe index as a value obtained by subtracting 1 from the number of uplink subframes; and if the number of downlink subframes is less than the number of uplink subframes and the downlink subframe index is greater than 0 and less than an integer obtained by subtracting 1 from the number of downlink subframes, determining the uplink subframe index as a value obtained by subtracting the parameter value from the downlink subframe index.

The method may further include: receiving feedback for the data burst in a subframe corresponding to the downlink subframe index; and, if the feedback is negative, beginning the retransmission of the data burst in a subframe corresponding to the uplink subframe index.

According to another aspect of the present invention, there is provided a method for a base station to communicate with a mobile station using a frame including one or more downlink subframes and one or more uplink subframes, the method including: transmitting resource allocation information to the mobile station in a subframe corresponding to a downlink subframe index; and beginning the reception of a data burst corresponding to the resource allocation information in a subframe corresponding to an uplink subframe index.

If the frame uses a time division duplex scheme, the uplink subframe index may be determined by at least using the downlink subframe index and a parameter value.

If the frame uses the time division duplex scheme and the number of downlink subframes is greater than or equal to the number of uplink subframes, the parameter value may be the greatest integer less than or equal to half the difference between the number of downlink subframes and the number of uplink subframes.

If the frame uses the time division duplex scheme and the number of downlink subframes is less than the number of uplink subframes, the parameter value may be an integer obtained by multiplying the smallest integer greater than or equal to half the difference between the number of uplink subframes and the number of downlink subframes by −1.

If the frame uses a frequency division duplex scheme, the uplink subframe index may be the remainder of division of the smallest integer greater than or equal to the sum of half the number of subframes in the frame and the downlink subframe index by the number of subframes in the frame.

According to another aspect of the present invention, there is provided a method for a mobile station to communicate with a base station using a frame including one or more downlink subframes and one or more uplink subframes, the method including: receiving a data burst in a subframe corresponding to a downlink subframe index; if the frame uses a time division duplex scheme, transmitting feedback for the data burst to the base station in an uplink subframe spaced apart by a first reference timing interval from the downlink subframe index; and if the frame uses a frequency division duplex scheme, transmitting feedback for the data burst to the base station in an uplink subframe spaced apart by a second reference timing interval from the downlink subframe index.

If the total number of subframes included in the frame using the frequency division duplex scheme is equal to the sum of the number of downlink subframes and the number of uplink subframes in the frame using the time division duplex scheme, the first reference timing interval and the second reference timing interval may be equal.

According to another aspect of the present invention, there is provided a method for a base station to communicate with a mobile station using a frame including one or more downlink subframes and one or more uplink subframes, the method including: transmitting a data burst in a subframe corresponding to a downlink subframe index; if the frame uses a time division duplex scheme, receiving feedback for the data burst from the mobile station in an uplink subframe spaced apart by a first reference timing interval from the downlink subframe index; and if the frame uses a frequency division duplex scheme, receiving feedback for the data burst from the mobile station in an uplink subframe spaced apart by a second reference timing interval from the downlink subframe index.

If the total number of subframes included in the frame using the frequency division duplex scheme is equal to the sum of the number of downlink subframes and the number of uplink subframes in the frame using the time division duplex scheme, the first reference timing interval and the second reference timing interval may be equal.

According to another aspect of the present invention, there is provided a method for a mobile station to communicate with a base station using a frame including one or more downlink subframes and one or more uplink subframes, the method including: receiving resource allocation information from the base station in a subframe corresponding to a downlink subframe index; if the frame uses a time division duplex scheme, transmitting a data burst corresponding to the resource allocation information to the base station in an uplink subframe spaced apart by a first reference timing interval from the downlink subframe index; and if the frame uses a frequency division duplex scheme, transmitting the data burst to the base station in an uplink subframe spaced apart by a second reference timing interval from the downlink subframe index.

If the total number of subframes included in the frame using the frequency division duplex scheme is equal to the sum of the number of downlink subframes and the number of uplink subframes in the frame using the time division duplex scheme, the first reference timing interval and the second reference timing interval may be equal.

The method may further include: receiving feedback for the data burst from the base station in a subframe corresponding to the downlink subframe index; and, if the feedback is negative, retransmitting the data burst to the base station in a subframe having the same uplink subframe index as the uplink subframe index of an uplink subframe index spaced apart by a first reference timing interval from the downlink subframe index.

According to another aspect of the present invention, there is provided a method for a base station to communicate with a mobile station using a frame including one or more downlink subframes and one or more uplink subframes, the method including: transmitting resource allocation information to the mobile station in a subframe corresponding to a downlink subframe index; if the frame uses a time division duplex scheme, receiving a data burst corresponding to the resource allocation information from the mobile station in an uplink subframe spaced apart by a first reference timing interval from the downlink subframe index; and if the frame uses a frequency division duplex scheme, receiving the data burst from the mobile station in an uplink subframe spaced apart by a second reference timing interval from the downlink subframe index. If the total number of subframes included in the frame using the frequency division duplex scheme is equal to the sum of the number of downlink subframes and the number of uplink subframes in the frame using the time division duplex scheme, the first reference timing interval and the second reference timing interval may be equal.

The method may further include transmitting feedback for the data burst to the mobile station in a subframe corresponding to the downlink subframe index.

According to another aspect of the present invention, there is provided a method for a mobile station to communicate with a base station using a time division duplex frame including D downlink subframes and U uplink subframes, the method including: beginning the reception of a subpacket in an m-th downlink subframe; and transmitting feedback for the subpacket to the base station in an n-th uplink subframe.

Ceil(x) is a function returning the smallest integer value greater than or equal to parameter x, and floor(x) is a function returning the greatest integer value less than or equal to parameter x.

According to another aspect of the present invention, there is provided a method for a base station to communicate with a mobile station using a time division duplex frame including D downlink subframes and U uplink subframes, the method including: beginning the transmission of a subpacket in an m-th downlink subframe; and receiving feedback for the subpacket from the mobile station in an n-th uplink subframe.

The index n may be obtained by the following equation:

$$For D > U$$

$$n = \{ \begin{matrix}0 , & for 0 \leq m < K \\ m - K , & for K \leq m < U + K \\ U - 1 , & for U + K \leq m < D\end{matrix} \\ where K = floor ( ( D - U ) / 2 ) , \\ For D \leq U \\ n = m - K \\ where K = - ceil ( U - D ) / 2 )$$

According to another aspect of the present invention, there is provided a method for a mobile station to communicate with a base station using a time division duplex frame including D downlink subframes and U uplink subframes, the method including: receiving resource allocation information in an l-th downlink subframe; and beginning the transmission of a subpacket corresponding to the resource allocation information in an m-th uplink subframe.

According to another aspect of the present invention, there is provided a method for a base station to communicate with a mobile station using a time division duplex frame including D downlink subframes and U uplink subframes, the method including: transmitting resource allocation information to the mobile station in an l-th downlink subframe; and beginning the reception of a subpacket corresponding to the resource allocation information in an m-th uplink subframe.

The index m may be obtained by the following equation:

$$For D \geq U$$

$$m = \{ \begin{matrix}0 , & for 0 \leq l < K \\ l - K , & for K \leq l < U + K \\ U - 1 , & for U + K \leq l < D \end{matrix} \\ where K = floor ( ( D - U ) / 2 ) \\ For D < U \\ m = \{ \begin{matrix}\{ 0 , … , l - K \} , & for l = 0 \\ l - K , & for 0 < l < D - 1 \\ \{ l - K , … , U - 1 \} , & for l = D - 1\end{matrix} \\ where K = - ceil ( U - D ) / 2 )$$

According to aspects of the present invention, the mobile communication system can obtain the same HARQ signal processing time in the TDD and FDD modes, and hence a HARQ operation between the base station and the terminal can be efficiently performed, thereby allowing the base station and the terminal to have a consistent HARQ processing time.

### BRIEF DESCRIPTION OF THE DRAWINGS

FIG. 1 illustrates a communication frame of a frequency division duplex (FDD) scheme in the conventional art.

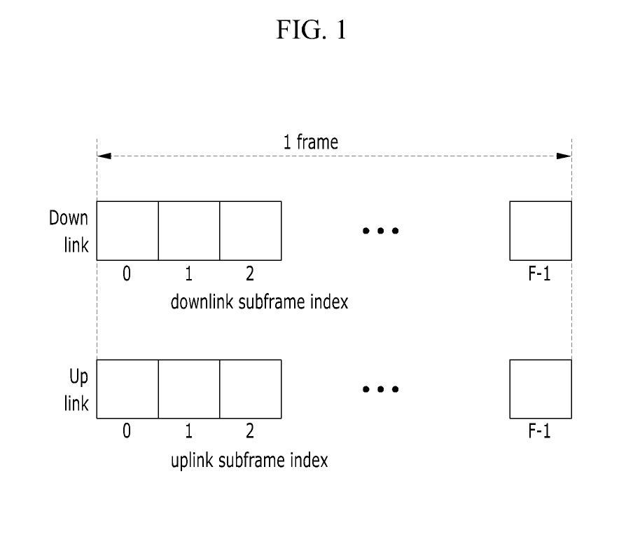

FIG. 2 illustrates a communication frame of a time division duplex (TDD) scheme in the conventional art.

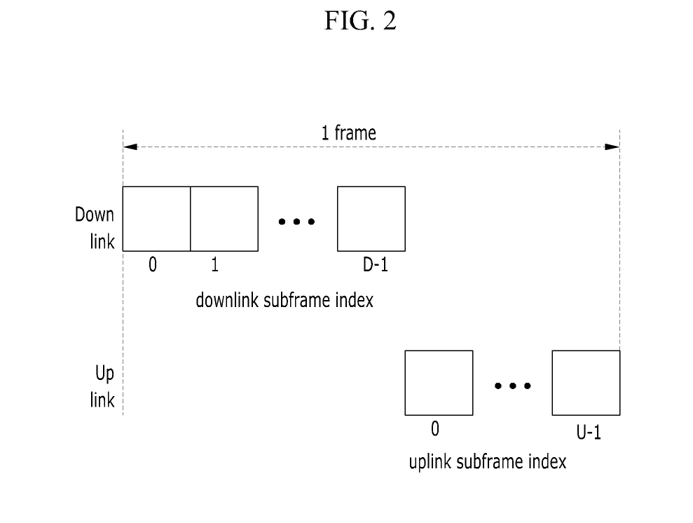

FIG. 3 is a flowchart illustrating a downlink data communication method according to an exemplary embodiment of the present invention.

FIG. 4 shows downlink HARQ timing according to an exemplary embodiment of the present invention.

FIG. 5 shows downlink HARQ timing according to another exemplary embodiment of the present invention.

FIG. 6 is a flowchart illustrating an uplink data communication method according to an exemplary embodiment of the present invention.

FIG. 7 shows uplink HARQ timing according to an exemplary embodiment of the present invention.

FIG. 8 shows uplink HARQ timing according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “include” and variations such as “includes” or “including” will be understood to imply the inclusion of stated elements but not the exclusion of any other elements.

In this specification, a mobile station (MS) may designate a terminal, a mobile terminal (MT), a subscriber station (SS), a portable subscriber station (PSS), user equipment (UE), an access terminal (AT), etc., and may include the entire or partial functions of the mobile terminal, the subscriber station, the portable subscriber station, the user equipment, etc.

In this specification, a base station (BS) may designate an access point (AP), a radio access station (RAS), a Node B, a base transceiver station (BTS), a mobile multihop relay (MMR)-BS, etc., and may include the entire or partial functions of the access point, the radio access station, the node B, the base transceiver station, the MMR-BS, etc.

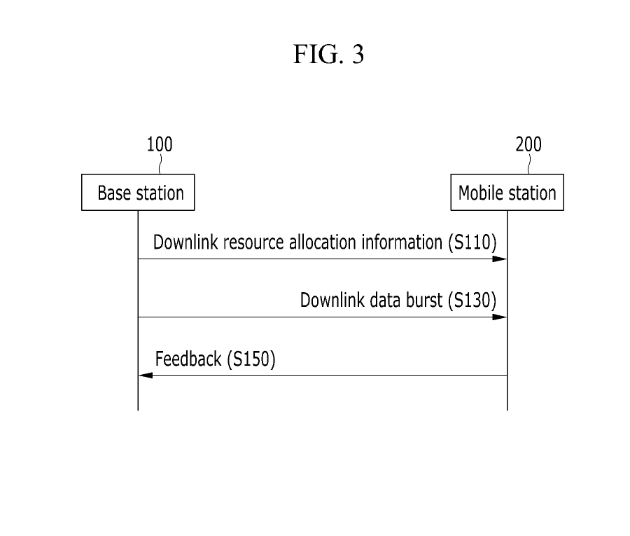

Hereinafter, a downlink data communication method according to an exemplary embodiment of the present invention will be described with reference to FIGS. 3 to 5.

FIG. 3 is a flowchart illustrating a downlink data communication method according to an exemplary embodiment of the present invention.

First, a base station 100 transmits downlink resource allocation information to a mobile station 200 in a subframe corresponding to a downlink subframe index l (S110). The downlink resource allocation information may be a control signal, such as an A-MAP (advanced MAP).

Next, the base station 100 begins the transmission of a downlink data burst, such as a subpacket, in a subframe corresponding to a downlink subframe index m through a downlink resource allocated by the downlink resource allocation information (S130).

The mobile station 200 decodes the received downlink data burst, and the mobile station 200 transmits ACK feedback as a positive response to the base station 100 if the decoding is successful, and transmits NACK feedback as a negative response to the base station 100 if the decoding fails (S150). The mobile station 200 uses a subframe corresponding to an uplink subframe index n for feedback transmission.

According to an exemplary embodiment of the present invention, the mobile station 200 may determine the uplink subframe index n according to Equation 1 or Equation 2. Equation 1 applies when a communication frame uses the frequency division duplex scheme, and Equation 2 applies when a communication frame uses the time division duplex scheme.

n=ceil(m+F/2)mod F (Equation 1)

Herein, mod is a modulo operation for obtaining a remainder. That is, mathematical formula “a=(x)mod(y)” shows that a is the remainder of division of x by y.

For D>U

n=0 for 0≦m<K

n=m−K, for K≦m<U+K

n=U−1, for U+K≦m<D

For D≦U

n=m−K (Equation 2)

Herein, the parameter is a parameter determined depending on system capability, such as channel bandwidth, the number of subframes, etc., in the time division duplex scheme. The parameter K is used to obtain HARQ reference timing interval. A downlink HARQ reference timing interval refers to an interval between a downlink subframe for downlink data burst transmission and a downlink subframe for HARQ feedback transmission.

According to an exemplary embodiment of the present invention, the mobile station 200 may determine the parameter K in Equation 2 according to Equation 3.

$$If the sum of D and U is an Odd \\ K = \{ \begin{matrix}ceil ( ( D - U ) / 2 ) , & for D \geq U \\ - ceil ( ( U - D ) / 2 ) , & for D < U\end{matrix} \\ Otherwise , \\ K = \{ \begin{matrix}floor ( ( D - U ) / 2 ) , & for D \geq U \\ - floor ( ( U - D ) / 2 ) , & for D < U\end{matrix} \qquad ( Equation 3 )$$

Herein, ceil(x) is a function returning the smallest integer value greater than or equal to parameter x. Floor(x) is a function returning the greatest integer value less than or equal to parameter x.

The downlink HARQ reference timing intervals for the parameter K calculated according to Equation 3 are shown in Table 2.

TABLE 2

| FDD | | TDD | | |
|---|---|---|---|---|
| (subframe) | | (subframe) | | |
| | HARQ Reference. | | HARQ Reference | |
| F | timing Interval | D:U | timing Interval | K |
| 5 | 2 | 3:2 | 1 | 1 |
| | | 2:3 | 2 | −1 |
| 6 | 2 | 4:2 | 2 | 1 |
| 7 | 3 | 4:3 | 2 | 1 |
| | | 3:4 | 3 | −1 |
| | | 5:2 | 2 | 2 |
| 8 | 3 | 5:3 | 3 | 1 |
| | | 6:2 | 3 | 2 |
| | | 3:5 | 3 | −1 |

According to Table 2, when the communication frame in the FDD mode and the communication frame in the TDD mode have the same number of subframes, the downlink HARQ reference timing intervals for the FDD mode and the TDD mode are different from each other. For example, the downlink HARQ reference timing interval for the FDD mode with F=5 is 2, whereas the downlink HARQ reference timing interval for the TDD mode with D:U=3:2 is 1.

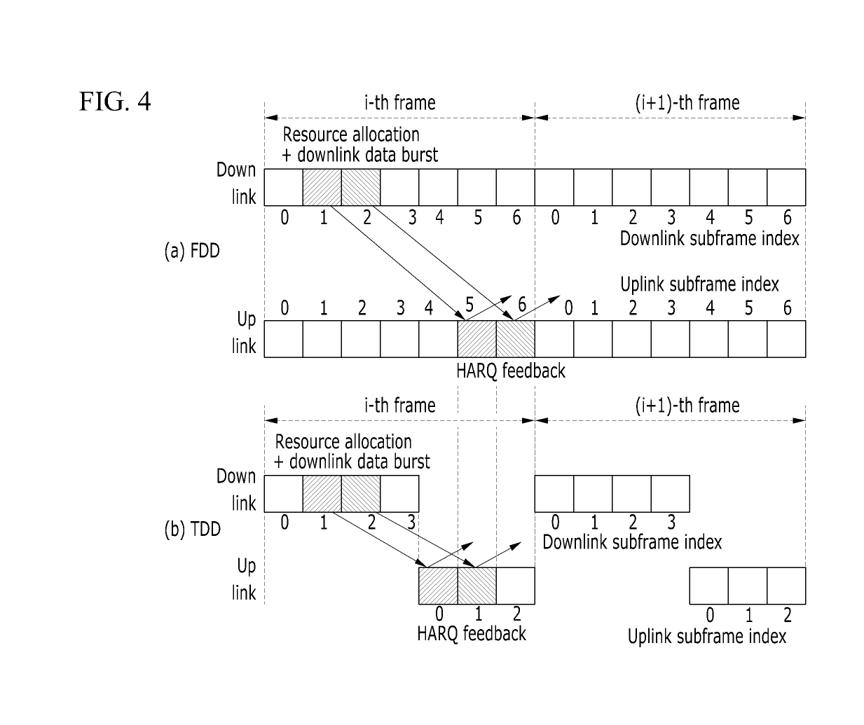

A downlink HARQ timing for the parameter K calculated according to Equation 3 will be described below with reference to FIG. 4.

FIG. 4 shows a downlink HARQ timing according to an exemplary embodiment of the present invention.

(a) of FIG. 4 shows downlink HARQ timing for the FDD mode with F=7, and (b) of FIG. 4 shows downlink HARQ timing for the TDD mode with D:U=4:3. According to Equation 3, the parameter K is equal to K=ceil((D−U)/2)=1.

According to (a) of FIG. 4, when the base station 100 transmits downlink resource allocation information and a downlink data burst to the mobile station 200 in a subframe corresponding to the downlink subframe index(m) 1, n=ceil(m+F/2) mod F=ceil (1+7/2) mod 7=5. Thus, the mobile station 200 transmits HARQ feedback for the data burst corresponding to m=1 to the base station 100 in a subframe corresponding to the uplink subframe index(n) 5. Also, when the base station 100 transmits downlink resource allocation information and a downlink data burst to the mobile station 200 in a subframe corresponding to the downlink subframe index(m) 2, the mobile station 200 transmits HARQ feedback for the data burst corresponding to m=2 to the base station 100 in a subframe corresponding to the uplink subframe index(n) 6.

On the other hand, according to (b) of FIG. 4, when the base station 100 transmits downlink resource allocation information and a downlink data burst to the mobile station 200 in a subframe corresponding to the downlink subframe index(m) 1, K≦m≦U+K. Thus, n is 0 by n=m−K=1−1=0. That is, the mobile station 200 transmits HARQ feedback for the data burst corresponding to m=1 to the base station 100 in a subframe corresponding to the uplink subframe index(n) 0. Also, when the base station 100 transmits downlink resource allocation information and a downlink data burst to the mobile station 200 in a subframe corresponding to the downlink subframe index(m) 2, the mobile station 200 transmits HARQ feedback for the data burst corresponding to m=2 to the base station 100 in a subframe corresponding to the uplink subframe index(n) 1.

According to FIG. 4, the downlink HARQ reference timing interval for the FDD mode is 3, and the downlink HARQ reference timing interval for the TDD mode is 2. When the parameter K is thus determined according to Equation 3, the HARQ signal processing time for the TDD mode may be shorter by 1 subframe than that for the FDD mode even if the communication frame for the FDD mode and the communication frame for the TDD have the same number of subframes.

Therefore, according to another exemplary embodiment of the present invention, the mobile station 200 may determine the parameter K in Equation 2 according to Equation 4 or Equation 5.

$$\begin{matrix}K = \{ \begin{matrix}floor ( ( D - U ) / 2 ) , & for D > U \\ - ceil ( ( U - D ) / 2 ) , & for D \leq U\end{matrix} & ( Equation 4 ) \\ K = \{ \begin{matrix}floor ( ( D - U ) / 2 ) , & for D \geq U \\ - ceil ( ( U - D ) / 2 ) , & for D < U\end{matrix} & ( Equation 5 )\end{matrix}$$

Since K=0 for D=U, Equation 4 is equivalent to Equation 5.

The downlink HARQ reference timing intervals for the parameter K calculated according to Equation 4 or Equation 5 are shown in Table 3

TABLE 3

| FDD | | TDD | | |
|---|---|---|---|---|
| (subframe) | | (subframe) | | |
| | HARQ Reference | | HARQ Reference | |
| F | timing Interval | D:U | timing Interval | K |
| 5 | 2 | 3:2 | 2 | 0 |
| | | 2:3 | 2 | −1 |
| 6 | 2 | 4:2 | 2 | 1 |
| 7 | 3 | 4:3 | 3 | 0 |
| | | 3:4 | 3 | −1 |
| | | 5:2 | 3 | 1 |
| 8 | 3 | 5:3 | 3 | 1 |
| | | 6:2 | 3 | 2 |
| | | 3:5 | 3 | −1 |

According to Table 3, when the communication frame in the FDD mode and the communication frame in the TDD mode have the same number of subframes, the downlink HARQ reference timing intervals for the FDD mode and the TDD mode are equal.

Downlink HARQ timing for the parameter K calculated according to Equation 4 or Equation 5 will be described below with reference to FIG. 4.

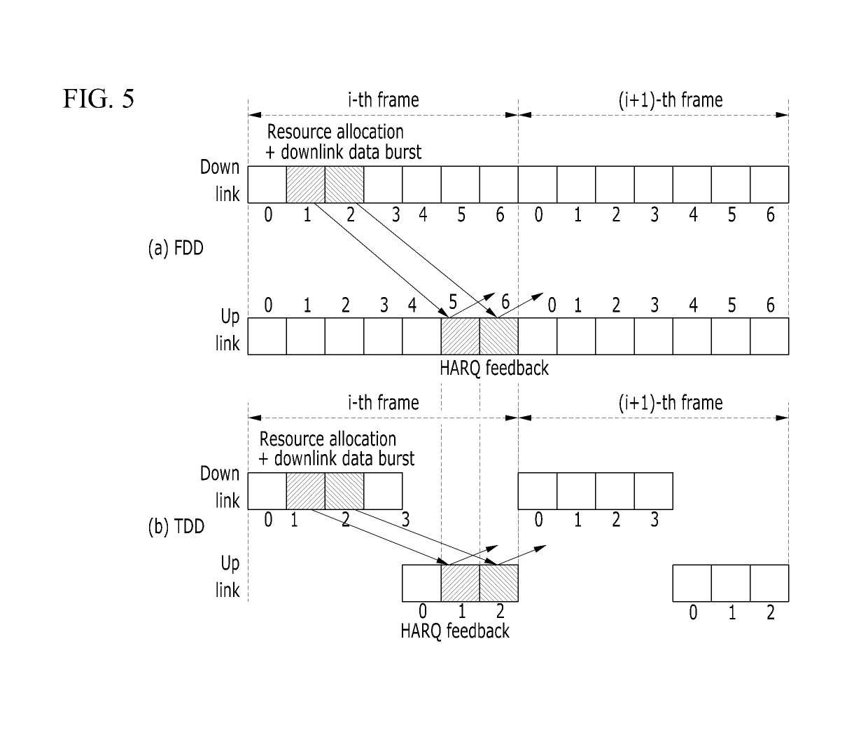

FIG. 5 shows downlink HARQ timing according to another exemplary embodiment of the present invention.

(a) of FIG. 5 shows downlink HARQ timing for the FDD mode with F=7, and (b) of FIG. 5 shows downlink HARQ timing for the TDD mode with D:U=4:3. According to Equation 4 or Equation 5, the parameter K is equal to K=floor((D−U)/2)=0.

According to (a) of FIG. 5, when the base station 100 transmits downlink resource allocation information and a downlink data burst to the mobile station 200 in a subframe corresponding to the downlink subframe index(m) 1, n=ceil(m+F/2) mod F=ceil (1+7/2) mod 7=5. Thus, the mobile station 200 transmits HARQ feedback for the data burst corresponding to m=1 to the base station 100 in a subframe corresponding to the uplink subframe index(n) 5. Also, when the base station 100 transmits downlink resource allocation information and a downlink data burst to the mobile station 200 in a subframe corresponding to the downlink subframe index(m) 2, the mobile station 200 transmits HARQ feedback for the data burst corresponding to m=2 to the base station 100 in a subframe corresponding to the uplink subframe index(n) 6.

On the other hand, according to (b) of FIG. 5, when the base station 100 transmits downlink resource allocation information and a downlink data burst to the mobile station 200 in a subframe corresponding to the downlink subframe index(m) 1, K≦m<U+K. Thus, n is 1 by n=m−K=1−0=1. That is, the mobile station 200 transmits HARQ feedback for the data burst corresponding to m=1 to the base station 100 in a subframe corresponding to the uplink subframe index(n)=1. Also, when the base station 100 transmits downlink resource allocation information and a downlink data burst to the mobile station 200 in a subframe corresponding to the downlink subframe index(m) 2, the mobile station 200 transmits HARQ feedback for the data burst corresponding to m=2 to the base station 100 in a subframe corresponding to the uplink subframe index(n) 2.

According to FIG. 5, the downlink HARQ reference timing interval for the FDD mode and the downlink HARQ reference timing interval for the TDD mode are both 3. As such, when the communication frame for the FDD mode and the communication frame for the TDD mode have the same number of subframes and the parameter K is determined according to Equation 4 or Equation 5, the TDD mode and the FDD mode obtain the same HARQ signal processing time. Through this, a HARQ operation between a base station and a terminal can be effectively performed, and the base station and the terminal can have a consistent HARQ processing time.

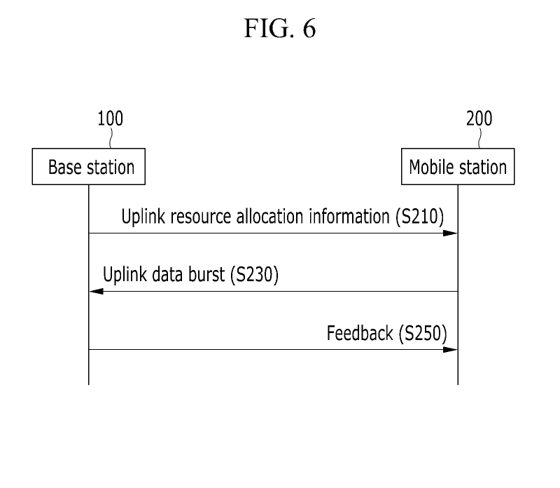

An uplink data communication method according to an exemplary embodiment of the present invention will be described below with reference to FIGS. 6 to 8.

FIG. 6 is a flowchart illustrating an uplink data communication method according to an exemplary embodiment of the present invention.

First of all, a base station 100 transmits uplink resource allocation information to a mobile station 200 in a subframe corresponding to a downlink subframe index l (S210). The uplink resource allocation information may be a control signal, such as an A-MAP (advanced MAP).

Next, the mobile station 100 begins the transmission of an uplink data burst, such as a subpacket, in a subframe corresponding to an uplink subframe index m through an uplink resource allocated by the uplink resource allocation information (S230).

The base station 100 decodes the received downlink data burst, and the base station 100 transmits ACK feedback as a positive response to the mobile station 200 if the decoding is successful, and transmits NACK feedback as a negative response to the mobile station 200 if the decoding fails (S250). The base station 100 uses a subframe corresponding to a downlink subframe index n for feedback transmission. The downlink subframe index n may be set equal to the downlink subframe index l.

According to an exemplary embodiment of the present invention, the base station 100 may determine the uplink subframe index m according to Equation 6 or Equation 7. Equation 6 applies when a communication frame uses the frequency division duplex scheme, and Equation 7 applies when a communication frame uses the time division duplex scheme.

m=ceil(1+F/2)mod F (Equation 6)

$$\begin{matrix}For D \geq U \\ m = \{ \begin{matrix}0 , & for 0 \leq l < K \\ l - K , & for K \leq l < U + K \\ U - 1 , & for U + K \leq l < D\end{matrix} \\ For D < U & ( Equation 7 ) \\ m = \{ \begin{matrix}\{ 0 , … , l - K \} , & for l = 0 \\ l - K , & for 0 < l < D - 1 \\ \{ l - K , … , U - 1 \} & for l = D - 1\end{matrix} & \end{matrix}$$

Herein, the parameter K is a parameter determined depending on system capability, such as channel bandwidth, the number of subframes, etc., in the time division duplex scheme. The parameter K is used to obtain a HARQ reference timing interval. An uplink HARQ reference timing interval refers to an interval between a downlink subframe for uplink resource allocation information transmission and an uplink subframe for uplink data burst transmission.

In Equation 7, m={x₁, x₂, . . . , xₙ} means that m is one of the values x₁ to xₙ.

According to an exemplary embodiment of the present invention, the mobile station 200 may determine the parameter K in Equation 7 according to Equation 3. For the parameter K calculated according to Equation 3, the uplink HARQ reference timing intervals are identical to the downlink HARQ reference timing intervals, which is shown in Table 2.

According to Table 2, when the communication frame in the FDD mode and the communication frame in the TDD mode have the same number of subframes, the uplink HARQ reference timing intervals for the FDD mode and the TDD mode are different from each other. For example, the uplink HARQ reference timing interval for the FDD mode with F=5 is 2, whereas the uplink HARQ reference timing interval for the TDD mode with D:U=3:2 is 1.

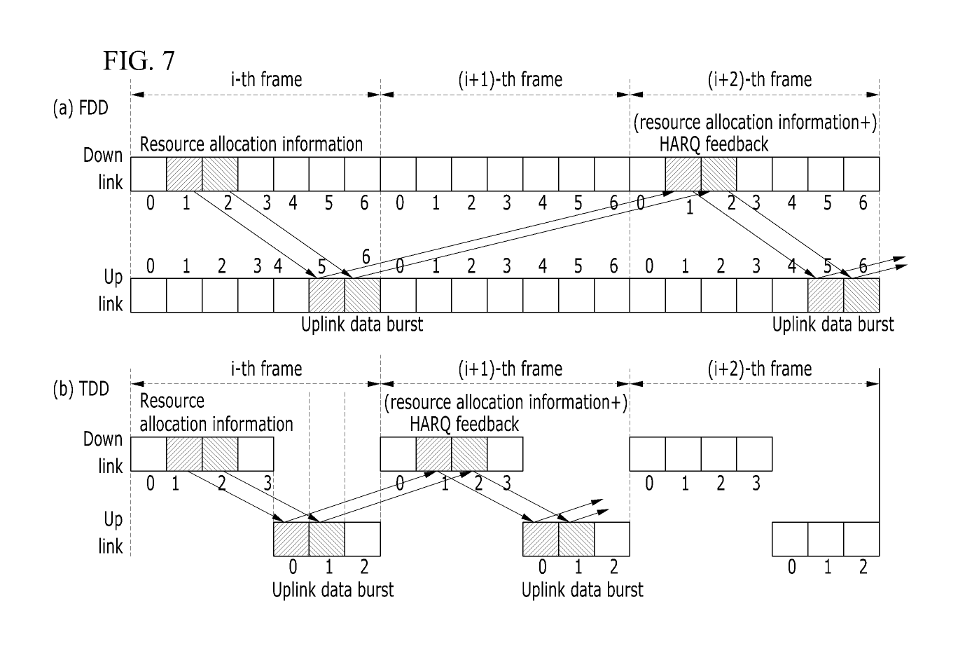

Uplink HARQ timing for the parameter K calculated according to Equation 3 will be described below with reference to FIG. 7.

FIG. 7 shows uplink HARQ timing according to an exemplary embodiment of the present invention.

(a) of FIG. 7 shows uplink HARQ timing for the FDD mode with F=7, and (b) of FIG. 7 shows uplink HARQ timing for the TDD mode with D:U=4:3. According to Equation 3, the parameter K is equal to K=ceil((D−U)/2)=1.

According to (a) of FIG. 7, when the base station 100 transmits uplink resource allocation information to the mobile station 200 in a subframe corresponding to the downlink subframe index(l) l, m=ceil(l+F/2) mod F=ceil (1+7/2) mod 7=5. Thus, the mobile station 200 transmits an uplink data burst to the base station 100 in a subframe corresponding to the uplink subframe index(m) 5 through an uplink resource allocated by the uplink resource allocation information corresponding to l=1. Afterwards, the base station 100 transmits HARQ feedback for the uplink data burst corresponding to m=5 to the mobile station 200 in a subframe corresponding to the downlink subframe index(n) 1. If this HARQ feedback is NACK, the mobile station 200 retransmits an uplink data burst to the base station 100 in a subframe corresponding to the uplink subframe index(m) 5.

Also, when the base station 100 transmits uplink resource allocation information to the mobile station 200 in a subframe corresponding to the downlink subframe index(l) 2, the mobile station 200 transmits an uplink data burst to the base station 100 in a subframe corresponding to the uplink subframe index(m) 6 through an uplink resource allocated by the uplink resource allocation information corresponding to l=2. Afterwards, the base station 100 transmits HARQ feedback for the uplink data burst corresponding to m=6 to the base station 100 in a subframe corresponding to the uplink subframe index(n) 2. If this HARQ feedback is NACK, the mobile station 200 retransmits an uplink data burst to the base station 100 in a subframe corresponding to the uplink subframe index(m) 6.

According to (b) of FIG. 7, when the base station 100 transmits uplink resource allocation information to the mobile station 200 in a subframe corresponding to the downlink subframe index(l) 1, K≦l<U+K. Thus, m=l−K=1−1=0. Therefore, the mobile station 200 transmits an uplink data burst to the base station 100 in a subframe corresponding to the uplink subframe index(m) 0 through the uplink resource allocated by the uplink resource allocation information corresponding to l=1. Afterwards, the base station 100 transmits HARQ feedback for the uplink data burst corresponding to m=0 to the mobile station 200 in a subframe corresponding to the downlink subframe index(n) 1. If this HARQ feedback is NACK, the mobile station 200 retransmits an uplink data burst to the base station 100 in the subframe corresponding to the uplink subframe index(m) 0.

Also, when the base station 100 transmits uplink resource allocation information to the mobile station 200 in a subframe corresponding to the downlink subframe index(l) 2, the mobile station 200 transmits an uplink data burst to the base station 100 in a subframe corresponding to the uplink subframe index(m) 1 through the uplink resource allocated by the uplink resource allocation information corresponding to l=2. Afterwards, the base station 100 transmits HARQ feedback for the uplink data burst corresponding to m=1 to the mobile station 200 in a subframe corresponding to the downlink subframe index(n) 2. If this HARQ feedback is NACK, the mobile station 200 retransmits an uplink data burst to the base station 100 in the subframe corresponding to the uplink subframe index(m) 1.

According to FIG. 7, the uplink HARQ reference timing interval for the FDD mode is 3, and the uplink HARQ reference timing interval for the TDD mode is 2. When the parameter K is thus determined according to Equation 3, the HARQ signal processing time for the TDD mode may be shorter by 1 subframe than that for the FDD mode even if the communication frame for the FDD mode and the communication frame for the TDD have the same number of subframes.

Therefore, according to another exemplary embodiment of the present invention, the mobile station 200 may determine the parameter K in Equation 7 according to Equation 4 or Equation 5.

For the parameter K calculated according to Equation 4 or Equation 5, the uplink HARQ reference timing intervals are identical to the downlink HARQ reference timing intervals, which is shown in Table 2.

According to Table 3, when the communication frame in the FDD mode and the communication frame in the TDD mode have the same number of subframes, the uplink HARQ reference timing intervals for the FDD mode and the TDD mode are equal.

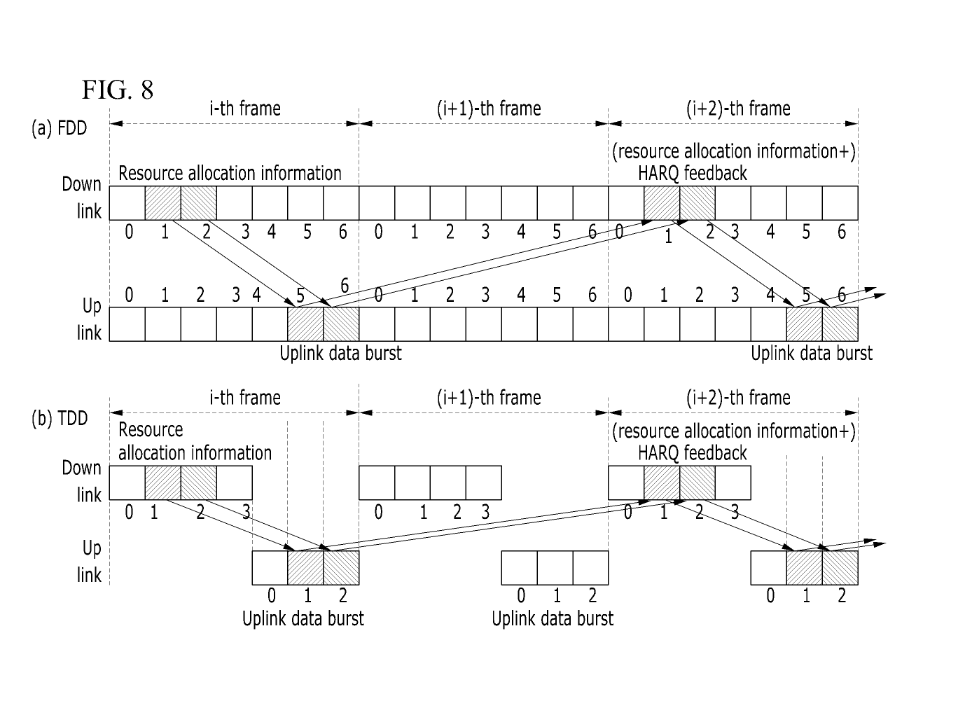

Uplink HARQ timing for the parameter K calculated according to Equation 4 or Equation 5 will be described below with reference to FIG. 8.

FIG. 8 shows uplink HARQ timing according to another exemplary embodiment of the present invention.

(a) of FIG. 8 shows uplink HARQ timing for the FDD mode with F=7, and (b) of FIG. 8 shows uplink HARQ timing for the TDD mode with D:U=4:3. According to Equation 4 or Equation 5, the parameter K is equal to K=floor((D−U)/2)=0.

According to (a) of FIG. 8, when the base station 100 transmits uplink resource allocation information to the mobile station 200 in a subframe corresponding to the downlink subframe index(l) 1, m=ceil(m+F/2) mod F=ceil (1+7/2) mod 7=5. Thus, the mobile station 200 transmits an uplink data burst to the base station 100 in a subframe corresponding to the uplink subframe index(m) 5 through an uplink resource allocated by the uplink resource allocation information corresponding to l=1. Afterwards, the base station 100 transmits HARQ feedback for the uplink data burst corresponding to m=5 to the mobile station 200 in a subframe corresponding to the downlink subframe index(n) 1. If this HARQ feedback is NACK, the mobile station 200 retransmits an uplink data burst to the base station 100 in a subframe corresponding to the uplink subframe index(m) 5.

Also, when the base station 100 transmits uplink resource allocation information to the mobile station 200 in a subframe corresponding to the downlink subframe index(l) 2, the mobile station 200 transmits an uplink data burst to the base station 100 in a subframe corresponding to the uplink subframe index(m) 6 through an uplink resource allocated by the uplink resource allocation information corresponding to l=2. Afterwards, the base station 100 transmits HARQ feedback for the uplink data burst corresponding to m=6 to the base station 100 in a subframe corresponding to the uplink subframe index(m) 2. If this HARQ feedback is NACK, the mobile station 200 retransmits an uplink data burst to the base station 100 in the subframe corresponding to the uplink subframe index(m) 6.

According to (b) of FIG. 8, when the base station 100 transmits uplink resource allocation information to the mobile station 200 in a subframe corresponding to the downlink subframe index(l) 1, K≦l<U+K. Thus, m=l−K=1−0=1. Therefore, the mobile station 200 transmits an uplink data burst to the base station 100 in a subframe corresponding to the uplink subframe index(m) 1 through the uplink resource allocated by the uplink resource allocation information corresponding to l=1. Afterwards, the base station 100 transmits HARQ feedback for the uplink data burst corresponding to m=1 to the mobile station 200 in a subframe corresponding to the downlink subframe index(n) 1. If this HARQ feedback is NACK, the mobile station 200 retransmits an uplink data burst to the base station 100 in the subframe corresponding to the uplink subframe index(m) 1.

Also, when the base station 100 transmits uplink resource allocation information to the mobile station 200 in a subframe corresponding to the downlink subframe index(l) 2, the mobile station 200 transmits an uplink data burst to the base station 100 in a subframe corresponding to the uplink subframe index(m) 2 through the uplink resource allocated by the uplink resource allocation information corresponding to l=2. Afterwards, the base station 100 transmits HARQ feedback for the uplink data burst corresponding to m=2 to the mobile station 200 in a subframe corresponding to the downlink subframe index(n) 2. If this HARQ feedback is NACK, the mobile station 200 retransmits an uplink data burst to the base station 100 in the subframe corresponding to the uplink subframe index(m) 2.

According to FIG. 8, the uplink HARQ reference timing interval for the FDD mode and the uplink HARQ reference timing interval for the TDD mode are both 3. As such, when the communication frame for the FDD mode and the communication frame for the TDD mode have the same number of subframes and the parameter K is determined according to Equation 4 or Equation 5, the TDD mode and the FDD mode obtain the same HARQ signal processing time. Through this, a HARQ operation between a base station and a terminal can be effectively performed, and the base station and the terminal can have a consistent HARQ processing time.

The exemplary embodiments of the present invention are not implemented only by a device and/or method, but can be implemented through a program for realizing functions corresponding to the configuration of the exemplary embodiments of the present invention and a recording medium having the program recorded thereon. These implementations can be realized by the ordinarily skilled person in the art from the description of the above-described exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A method for a mobile station to communicate with a base station using a frame comprising one or more downlink subframes and one or more uplink subframes, the method comprising:
beginning the reception of a data burst in a subframe corresponding to a downlink subframe index;
if the frame uses a time division duplex scheme and the number of downlink subframes is greater than the number of uplink subframes, determining a parameter value as the greatest integer less than or equal to half the difference between the number of downlink subframes and the number of uplink subframes;
if the frame uses the time division duplex scheme, determining an uplink subframe index for feedback transmission by at least using the downlink subframe index and the parameter value; and
transmitting feedback for the data burst to the base station in a subframe corresponding to the uplink subframe index.

2. The method of claim 1, further comprising, if the frame uses the time division duplex scheme and the number of downlink subframes is less than or equal to the number of uplink subframes, determining the parameter value as an integer obtained by multiplying the smallest integer greater than or equal to half the difference between the number of uplink subframes and the number of downlink subframes by −1.

3. The method of claim 2, wherein the determining of the uplink subframe index if the frame uses the time division duplex scheme further comprises:
if the number of downlink subframes is greater than the number of uplink subframes, the downlink subframe index is greater than or equal to the parameter value, and the downlink subframe index is less than the sum of the parameter value and the number of uplink subframes, determining the uplink subframe index as a value obtained by subtracting the parameter value from the downlink subframe index;
if the number of downlink subframes is greater than the number of uplink subframes, the downlink subframe index is greater than or equal to 0, and the downlink subframe index is less than the parameter value, determining the uplink subframe index as 0;
if the number of downlink subframes is greater than the number of uplink subframes, the downlink subframe index is greater than or equal to the sum of the parameter value and the number of uplink subframes, and the downlink subframe index is less than the number of downlink subframes, determining the uplink subframe index as a value obtained by subtracting 1 from the number of uplink subframes; and
if the number of downlink subframes is less than or equal to the number of uplink subframes, determining the uplink subframe index as a value obtained by subtracting the parameter value from the downlink subframe index.

4. The method of claim 1, further comprising, if the frame uses a frequency division duplex scheme, determining the uplink subframe index for feedback transmission as the remainder of division of the smallest integer greater than or equal to the sum of half the number of subframes in the frame and the downlink subframe index by the number of subframes in the frame.

5. A method for a base station to communicate with a mobile station using a frame comprising one or more downlink subframes and one or more uplink subframes, the method comprising:
beginning the transmission of a data burst in a subframe corresponding to a downlink subframe index; and
receiving feedback for the data burst from the mobile station in a subframe corresponding to an uplink subframe index,
wherein, if the frame uses a time division duplex scheme, the uplink subframe index is determined by at least using the downlink subframe index and a parameter value, and
if the frame uses the time division duplex scheme and the number of downlink subframes is greater than the number of uplink subframes, the parameter value is the greatest integer less than or equal to half the difference between the number of downlink subframes and the number of uplink subframes.

6. The method of claim 5, wherein, if the frame uses the time division duplex scheme and the number of downlink subframes is less than or equal to the number of uplink subframes, the parameter value is an integer obtained by multiplying the smallest integer greater than or equal to half the difference between the number of uplink subframes and the number of downlink subframes by −1.

7. The method of claim 5, wherein, if the frame uses a frequency division duplex scheme, the uplink subframe index is the remainder of division of the smallest integer greater than or equal to the sum of half the number of subframes in the frame and the downlink subframe index by the number of subframes in the frame.

8. A method for a mobile station to communicate with a base station using a frame comprising one or more downlink subframes and one or more uplink subframes, the method comprising:
receiving resource allocation information in a subframe corresponding to a downlink subframe index;
if the frame uses a time division duplex scheme and the number of downlink subframes is greater than or equal to the number of uplink subframes, determining a parameter value as the greatest integer less than or equal to half the difference between the number of downlink subframes and the number of uplink subframes;
if the frame uses the time division duplex scheme, determining an uplink subframe index by at least using the downlink subframe index and the parameter value; and
beginning the transmission of a data burst corresponding to the resource allocation information in a subframe corresponding to the uplink subframe index.

9. The method of claim 8, further comprising, if the frame uses the time division duplex scheme and the number of downlink subframes is less than the number of uplink subframes, determining the parameter value as an integer obtained by multiplying the smallest integer greater than or equal to half the difference between the number of uplink subframes and the number of downlink subframes by −1.

10. The method of claim 9, wherein the determining of the uplink subframe index if the frame uses the time division duplex scheme further comprises:
if the number of downlink subframes is greater than or equal to the number of uplink subframes, the downlink subframe index is greater than or equal to the parameter value, and the downlink subframe index is less than the sum of the parameter value and the number of uplink subframes, determining the uplink subframe index as a value obtained by subtracting the parameter value from the downlink subframe index;
if the number of downlink subframes is greater than or equal to the number of uplink subframes, the downlink subframe index is greater than or equal to 0, and the downlink subframe index is less than the parameter value, determining the uplink subframe index as 0;
if the number of downlink subframes is greater than or equal to the number of uplink subframes, the downlink subframe index is greater than or equal to the sum of the parameter value and the number of uplink subframes, and the downlink subframe index is less than the number of downlink subframes, determining the uplink subframe index as a value obtained by subtracting 1 from the number of uplink subframes; and
if the number of downlink subframes is less than the number of uplink subframes and the downlink subframe index is greater than 0 and less than an integer obtained by subtracting 1 from the number of downlink subframes, determining the uplink subframe index as a value obtained by subtracting the parameter value from the downlink subframe index.

11. The method of claim 8, further comprising:
receiving feedback for the data burst in a subframe corresponding to the downlink subframe index; and,
if the feedback is negative, beginning the retransmission of the data burst in a subframe corresponding to the uplink subframe index.

12. A method for a base station to communicate with a mobile station using a frame comprising one or more downlink subframes and one or more uplink subframes, the method comprising:
transmitting resource allocation information to the mobile station in a subframe corresponding to a downlink subframe index; and
beginning the reception of a data burst corresponding to the resource allocation information in a subframe corresponding to an uplink subframe index,
wherein, if the frame uses a time division duplex scheme, the uplink subframe index is determined by at least using the downlink subframe index and a parameter value, and
if the frame uses the time division duplex scheme and the number of downlink subframes is greater than or equal to the number of uplink subframes, the parameter value is the greatest integer less than or equal to half the difference between the number of downlink subframes and the number of uplink subframes.

13. The method of claim 12, wherein, if the frame uses the time division duplex scheme and the number of downlink subframes is less than the number of uplink subframes, the parameter value is an integer obtained by multiplying the smallest integer greater than or equal to half the difference between the number of uplink subframes and the number of downlink subframes by −1.

14. The method of claim 12, wherein, if the frame uses a frequency division duplex scheme, the uplink subframe index is the remainder of division of the smallest integer greater than or equal to the sum of half the number of subframes in the frame and the downlink subframe index by the number of subframes in the frame.

15. A method for a mobile station to communicate with a base station using a frame comprising one or more downlink subframes and one or more uplink subframes, the method comprising:
receiving a data burst in a subframe corresponding to a downlink subframe index;
if the frame uses a time division duplex scheme, transmitting feedback for the data burst to the base station in an uplink subframe spaced apart by a first reference timing interval from the downlink subframe index; and
if the frame uses a frequency division duplex scheme, transmitting feedback for the data burst to the base station in an uplink subframe spaced apart by a second reference timing interval from the downlink subframe index,
wherein, if the total number of subframes included in the frame using the frequency division duplex scheme is equal to the sum of the number of downlink subframes and the number of uplink subframes in the frame using the time division duplex scheme, the first reference timing interval and the second reference timing interval are equal.

16. A method for a base station to communicate with a mobile station using a frame comprising one or more downlink subframes and one or more uplink subframes, the method comprising:
transmitting a data burst in a subframe corresponding to a downlink subframe index;
if the frame uses a time division duplex scheme, receiving feedback for the data burst from the mobile station in an uplink subframe spaced apart by a first reference timing interval from the downlink subframe index; and
if the frame uses a frequency division duplex scheme, receiving feedback for the data burst from the mobile station in an uplink subframe spaced apart by a second reference timing interval from the downlink subframe index,
wherein, if the total number of subframes included in the frame using the frequency division duplex scheme is equal to the sum of the number of downlink subframes and the number of uplink subframes in the frame using the time division duplex scheme, the first reference timing interval and the second reference timing interval are equal.

17. A method for a mobile station to communicate with a base station using a frame comprising one or more downlink subframes and one or more uplink subframes, the method comprising:
receiving resource allocation information from the base station in a subframe corresponding to a downlink subframe index;
if the frame uses a time division duplex scheme, transmitting a data burst corresponding to the resource allocation information to the base station in an uplink subframe spaced apart by a first reference timing interval from the downlink subframe index; and
if the frame uses a frequency division duplex scheme, transmitting the data burst to the base station in an uplink subframe spaced apart by a second reference timing interval from the downlink subframe index,
wherein, if the total number of subframes included in the frame using the frequency division duplex scheme is equal to the sum of the number of downlink subframes and the number of uplink subframes in the frame using the time division duplex scheme, the first reference timing interval and the second reference timing interval are equal.

18. The method of claim 17, further comprising:
receiving feedback for the data burst from the base station in a subframe corresponding to the downlink subframe index; and
if the feedback is negative, retransmitting the data burst to the base station in a subframe having the same uplink subframe index as the uplink subframe index of an uplink subframe index spaced apart by a first reference timing interval from the downlink subframe index.

19. A method for a base station to communicate with a mobile station using a frame comprising one or more downlink subframes and one or more uplink subframes, the method including:
transmitting resource allocation information to the mobile station in a subframe corresponding to a downlink subframe index;
if the frame uses a time division duplex scheme, receiving a data burst corresponding to the resource allocation information from the mobile station in an uplink subframe spaced apart by a first reference timing interval from the downlink subframe index; and
if the frame uses a frequency division duplex scheme, receiving the data burst from the mobile station in an uplink subframe spaced apart by a second reference timing interval from the downlink subframe index,
wherein, if the total number of subframes included in the frame using the frequency division duplex scheme is equal to the sum of the number of downlink subframes and the number of uplink subframes in the frame using the time division duplex scheme, the first reference timing interval and the second reference timing interval are equal.

20. The method of claim 19, further comprising: transmitting feedback for the data burst to the mobile station in a subframe corresponding to the downlink subframe index.

21. A method for a mobile station to communicate with a base station using a time division duplex frame comprising D downlink subframes and U uplink subframes, the method comprising:
beginning the reception of a subpacket in an m-th downlink subframe; and
transmitting feedback for the subpacket to the base station in an n-th uplink subframe,
wherein the index n is obtained by the following equation:
$$For D > U$$
$$n = \{ \begin{matrix}0 , & for 0 \leq m < K \\ m - K , & for K \leq m < U + K \\ U - 1 , & for U + K \leq m < D\end{matrix} \\ where K = floor ( ( D - U ) / 2 ) , \\ For D \leq U \\ n = m - K \\ where K = - ceil ( U - D ) / 2 ) ,$$
wherein ceil(x) is a function returning the smallest integer value greater than or equal to parameter x, and floor(x) is a function returning the greatest integer value less than or equal to parameter x.

22. A method for a base station to communicate with a mobile station using a time division duplex frame comprising D downlink subframes and U uplink subframes, the method comprising:
beginning the transmission of a subpacket in an m-th downlink subframe; and
receiving feedback for the subpacket from the mobile station in an n-th uplink subframe,
wherein the index n is obtained by the following equation:
$$For D > U$$
$$n = \{ \begin{matrix}0 , & for 0 \leq m < K \\ m - k , & for K \leq m < U + K \\ U - 1 , & for U + K \leq m < D\end{matrix} \\ where K = floor ( ( D - U ) / 2 ) , \\ For D \leq U \\ n = m - K \\ where K = - ceil ( U - D ) / 2 )$$
wherein ceil(x) is a function returning the smallest integer value greater than or equal to parameter x, and floor(x) is a function returning the greatest integer value less than or equal to parameter x.

23. A method for a mobile station to communicate with a base station using a time division duplex frame comprising D downlink subframes and U uplink subframes, the method comprising:
receiving resource allocation information in an l-th downlink subframe; and
beginning the transmission of a subpacket corresponding to the resource allocation information in an m-th uplink subframe,
wherein the index m is obtained by the following equation:
$$For D \geq U$$
$$m = \{ \begin{matrix}0 , & for 0 \leq l < K \\ l - K , & for K \leq l < U + K \\ U - 1 , & for U + K \leq l < D\end{matrix} \\ where K = floor ( ( D - U ) / 2 ) \\ For D < U \\ m = \{ \begin{matrix}\{ 0 , … , l - K \} , & for l = 0 \\ l - K , & for 0 < l < D - 1 \\ \{ l - K , … , U - 1 \} , & for l = D - 1\end{matrix} \\ where K = - ceil ( U - D ) / 2 )$$
wherein ceil(x) is a function returning the smallest integer value greater than or equal to parameter x, and floor(x) is a function returning the greatest integer value less than or equal to parameter x.

24. A method for a base station to communicate with a mobile station using a time division duplex frame comprising D downlink subframes and U uplink subframes, the method comprising:
transmitting resource allocation information to the mobile station in an l-th downlink subframe; and
beginning the reception of a subpacket corresponding to the resource allocation information in an m-th uplink subframe,
wherein the index m is obtained by the following equation:
$$For D \geq U$$
$$m = \{ \begin{matrix}0 , & for 0 \leq l < K \\ l - K , & for K \leq l < U + K \\ U - 1 , & for U + K \leq l < D\end{matrix} \\ where K = floor ( ( D - U ) / 2 ) \\ For D < U \\ m = \{ \begin{matrix}\{ 0 , … , l - K \} , & for l = 0 \\ l - K , & for 0 < l < D - 1 \\ \{ l - K , … , U - 1 \} , & for l = D - 1\end{matrix} \\ where K = - ceil ( U - D ) / 2 )$$
wherein ceil(x) is a function returning the smallest integer value greater than or equal to parameter x, and floor(x) is a function returning the greatest integer value less than or equal to parameter x.
